(19) United States
(12) Patent Application Publication
(10) Pub. No.: US 2021/0141877 A1
(43) Pub. Date: May 13, 2021

(54) USER INTERFACE MODIFICATION

(71) Applicant: Hewlett-Packard Development Company, L.P., Spring, TX (US)

(72) Inventor: Vinicius de Nardi Stock da Silva, Porto Alegre (BR)

(73) Assignee: Hewlett-Packard Development Company, L.P., Spring, TX (US)

(21) Appl. No.: 17/047,425

(22) PCT Filed: Jul. 30, 2018
(86) PCT No.: PCT/US2018/044297

§ 371 Date: Oct. 14, 2020

(51) Int. Cl. G06F 21/31; G06F 40/226; G06F 3/048; A63F 13/79; G06F 9/451; G06F 21/83; G06N 20/00; G06N 5/04

(52) U.S. Cl. CPC G06F 21/316; G06F 40/226; G06F 3/048; G06N 5/04; G06F 9/451; G06F 21/83; G06N 20/00; A63F 13/79

(57) ABSTRACT

Example implementations relate to user interface modification. In some examples, a computing device can include a processing resource and a memory resource storing non-transitory machine-readable instructions to cause the processing resource to analyze an input received from an input device for a typing pattern, determine a user profile corresponding to the analyzed typing pattern from the input device, and modify a user interface of the computing device based on the determined user profile.

### BACKGROUND

A keyboard can be utilized as an input mechanism for an electronic device. For example, a keyboard can be utilized to provide inputs for letters, numbers, and/or other symbols or characters to an electronic device, among other possibilities. Examples of electronic devices having a keyboard can include computing devices such as laptop computers, desktop computers, and/or mobile devices, among other types of computing devices. A user can interact with the computing device via the keyboard and a user interface.

### BRIEF DESCRIPTION OF THE DRAWINGS

FIG. 1 is a diagram of an example system for user interface modification consistent with the disclosure.

FIG. 2 is a diagram of an example computing device for user interface modification consistent with the disclosure.

FIG. 3 is a diagram of an example system for user interface modification consistent with the disclosure.

FIG. 4 is an example of a method consistent with the disclosure.

### DETAILED DESCRIPTION

Electronic devices may include a user interface. As used herein, the term “user interface” refers to a mechanism by which a user interacts with a computing device. For example, the user interface can provide (e.g., display and/or present) information to the user of a computing device and/or receive information from the user of the computing device. For instance, the user interface can be a graphical user interface (GUI) that can provide information to and/or receive information from the user of the computing device. The user interface can be presented on a display of the computing device. As used herein, the term “display” refers to a device for presentation of information in a visual form. For example, a display can include a television, computer monitor, mobile device screen, other type of display, or any combination thereof which may be connected to the computing device and can receive a video signal output from the computing device.

Some computing devices may include user profiles that are specific to individual users. As used herein, the term “user profile” refers to a collection of settings and/or information that are associated with a particular user. For example, a computing device may include a user profile for a first user that includes display settings, application settings, network connections, and/or other settings/information, and may be represented to the user as a digital representation via the user interface of the computing device. Additionally, a computing device may include another different user profile for a second user that can include display settings, application settings, network connections, and/or other settings/information which may be different than those of the first user and may be digitally represented as such via the user interface of the computing device. In other words, a user profile can be a collection of settings and/or information unique to a particular user of the computing device which can be digitally represented to the particular user via the user interface of the computing device.

As described above, different users may have unique and/or different user profiles. Accordingly, the different user profiles can include different settings and/or information.

Creating a uniquely tailored user experience for a user utilizing the computing device can provide the user with a higher sense of value from the experience of interacting with the computing device. For instance, a customized user experience may leave a user with a better feeling of value relative to a standardized user experience with standard settings and/or information.

Different users may interact with the computing device in different ways. For example, typing patterns of various users may differ.

User interface modification according to the disclosure can allow for customization of a user experience by modifying a user interface of the computing device based on a user profile. User interface modification according to the disclosure can provide the user with a uniquely tailored user experience. Utilizing typing patterns to customize the user experience by modifying the user interface can allow the computing device to adapt a user profile associated with a particular user based on how the particular user is utilizing the computing device. The uniquely tailored user experience can provide a feeling of value to the user relative to a standardized user experience, which may just include a standard user interface utilizing standard settings for use by many different users.

FIG. 1 is a diagram of an example system 100 for user interface modification consistent with the disclosure. As illustrated in FIG. 1, system 100 can include computing device 102, user 110, and input 108. Computing device 102 can include input device 104 and user interface 106.

As illustrated in FIG. 1, computing device 102 can include input device 104 and user interface 106. For instance, in some examples input device 104 can be a keyboard. As used herein, the term “keyboard” refers to a device utilizing an arrangement of buttons (e.g., keys) to input information into a computing device. In some examples, input device 104 can be a controller. As used herein, the term “controller” refers to an input device utilizing an arrangement of buttons, directional pads, analog sticks, joysticks, motion detection, touch screens, and/or other inputs to input information into a computing device. For example, the controller can be a game controller, as is further described herein.

In some examples, input device 104 can be a keyboard and can be a peripheral device connected to computing device 102. For example, the keyboard can utilize mechanical mechanisms such as scissor mechanisms or butterfly mechanisms for operation of keys of the keyboard. Utilizing these mechanisms can allow for keyboards to input information such as characters, letters, numbers, and/or other symbols via the keys of the keyboard to a computing device.

In some examples, input device 104 can be a keyboard and can be included as part of computing device 102. For example, the keyboard can be an onboard keyboard, such as a keyboard included in a laptop computing device. The keyboard can utilize mechanical mechanisms such as scissor mechanisms or butterfly mechanisms for operation of keys of the keyboard. Utilizing these mechanisms can allow for keyboards to input information such as characters, letters, numbers, and/or other symbols via the keys of the keyboard to a computing device

In some examples, input device 104 can be a keyboard that is digitally displayed via user interface 106. For example, the keyboard can include icons displayed on user interface 106 to allow a user to input information such as characters, letters, numbers, and/or other symbols via the keys (e.g., icons) of the keyboard. For example, the keyboard can be displayed on user interface 106 of computing device 102 via a touch-screen display such that user 110 can touch a key (e.g., an icon) displayed on user interface 106 to input information into computing device 102.

As used herein, the term “key” can, for example, refer to a mechanism to control an input to a computing device. For example, as described above, a key can be a mechanical mechanism on a physical keyboard, or can be an icon that is digitally displayed on user interface 106. As used herein, the term “computing device” can, for example, refer to a laptop computer, a desktop computer, a server, storage and/or networking equipment, and/or a mobile device, among other types of computing devices. A mobile device can include a phone (e.g., a smart phone), a tablet, a personal digital assistant (PDA), smart glasses, and/or a wrist-worn device (e.g., a smart watch), among other types of mobile devices.

In some examples, input device 104 can be a controller (e.g., a game controller) and can be a peripheral device connected (wired or wirelessly) to computing device 102. For example, the game controller can utilize input mechanisms such as buttons, directional pads, analog sticks, joysticks, motion detection, touch screens, and/or other inputs to input information into a computing device, for instance, for controlling/directing inputs for a video game.

Computing device 102 can analyze an input 108 received from an input device. As used herein, the term “input” refers to introduction of data to a computing device. For example, user 110 can input data, such as characters, letters, numbers, directional inputs, and/or other data via buttons, keys, and/or joysticks, among other input mechanisms of input device 104 to computing device 102.

Computing device 102 can analyze the input 108 from input device 104 for a typing pattern. As used herein, the term “typing pattern” refers to typing characteristics of a user. For example, different users may have different typing characteristics, which can be measured by typing pattern metrics, as is further described herein. For example, user 110 may have typing characteristics that can differ from a different user that may use computing device 102.

As described above, a typing pattern can be defined by typing pattern metrics. For example, typing pattern metrics may include a time between each keystroke in the typing pattern, a time each key is pressed during each keystroke in the typing pattern, spelling accuracy in the typing pattern, words per minute in the typing pattern, pressure applied during each keystroke, length of time between N number of consecutive key strokes, among other typing pattern metrics. For example, a user can input 108 information via input device 104 to computing device 102, where the input 108 can include the time between each keystroke being 0.5 seconds, the time each key is pressed during each keystroke being 1 second, a spelling accuracy of 80%, and a words per minute metric of 40.

Based on the typing pattern determined from the analyzed input 108 from input device 104, computing device 102 can determine a user profile corresponding to the analyzed typing pattern from input device 104. For example, computing device 102 can determine that based on the 0.5 seconds between keystrokes, the 1 second key press time, 80% spelling accuracy, and 40 words per minute, the user utilizing computing device 102 is user 110. Accordingly, computing device 102 can determine that a user profile corresponding to user 110 should be utilized, as is further described herein.

In some examples, the user profile can be a predetermined user profile. For example, computing device 102 can analyze the typing pattern metrics via machine learning to generate a particular user profile that corresponds with a particular user (e.g., user 110). For example, computing device 102 can analyze the typing pattern metrics via classification machine learning, such as a Naïve Bayes classifier, among other types of machine learning algorithms to generate the predetermined user profile that corresponds with user 110.

Computing device 102 can modify a user interface 106 of computing device 102 based on the determined user profile. For example, as described above, a user profile can include settings and/or information associated with a particular user. Accordingly, computing device 102 can determine the user profile to be a user profile associated with user 110. Computing device 102 can modify a user interface 106 of computing device 102 based on the settings and/or information (e.g., display settings, application settings, network connections, and/or other settings/information) associated with the user profile of user 110, as is further described herein.

Modification of user interface 106 can include enabling text prediction. For example, computing device 102 can determine, based on an analyzed typing pattern, that a typing pattern metric is below a threshold typing pattern metric, and can modify user interface 106 by enabling text prediction based on the typing pattern metric being below the threshold typing pattern metric, as is further described herein. For example, computing device 102 can determine a time between each keystroke (e.g., 1 second) is less than a threshold time between each keystroke (e.g., 0.5 seconds), time each key is pressed (e.g., 1 second) is longer than a threshold time for each key press (e.g., 0.5 seconds), spelling accuracy (e.g., 80%) is less than a threshold spelling accuracy (e.g., 90%), words per minute (e.g., 40) is less than a threshold words per minute (e.g., 45), among other typing pattern metrics that may be below a threshold typing pattern metric.

Computing device 102 can modify user interface 106 by enabling text prediction based on a typing pattern metric being below a threshold typing pattern metric. As used herein, the term “text prediction” refers to an input system where a key press results in a prediction of a word such that an entire word can be input by a single keypress. For example, user 110 may be writing a long dissertation and has spent many hours working on the dissertation. As user 110 begins work on the dissertation, user 110 is rested and focused, typing with high speed and accuracy. However, as user 110 continues to work, user 110 becomes fatigued and begins to make mistakes. For example, user 110 may have a spelling accuracy that drops from 95% initially to 80%, falling below a threshold spelling accuracy of 90%, Based on the typing pattern metric of spelling accuracy falling below the threshold typing pattern metric, computing device 102 can modify user interface 106 by enabling text prediction. Text prediction can assist user 110 by suggesting words as user 110 types, which can assist in typing pattern metric performance (e.g., increase spelling accuracy, words per minute, etc.)

In some examples, the text prediction can be in the form of a prompt. For instance, when the spelling accuracy of user 110 drops below the threshold spelling accuracy, computing device 102 can modify user interface 106 by prompting the user for suggested spellings. For instance, user 110 may have spelled a word wrong, and computing device 102 can modify user interface 106 display a prompt to user 110 saying “Did you mean [correct spelling of misspelled word]?”.

Modification of user interface 106 can include displaying a suggestive prompt. For example, as described above, computing device 102 can determine, based on an analyzed typing pattern, that a typing pattern metric is below a threshold typing pattern metric, and can modify user interface 106 by displaying a suggestive prompt based on the typing pattern metric being below the threshold typing pattern metric. For example, computing device 102 can determine a time between each keystroke (e.g., 1 second) is less than a threshold time between each keystroke (e.g., 0.5 seconds), time each key is pressed (e.g., 1 second) is longer than a threshold time for each key press (e.g., 0.5 seconds), spelling accuracy (e.g., 80%) is less than a threshold spelling accuracy (e.g., 90%), words per minute (e.g., 40) is less than a threshold words per minute (e.g., 45), among other typing pattern metrics that may be below a threshold typing pattern metric.

Computing device 102 can modify user interface 106 by displaying a suggestive prompt based on a typing pattern metric being below a threshold typing pattern metric. As used herein, the term “prompt” refers to a suggestive phrase. Continuing with the example from above, after many hours working on the dissertation, user 110 may become fatigued and a typing pattern metric of user 110 may drop below a threshold typing pattern metric. Based on the typing pattern metric falling below a threshold typing pattern metric, computing device 102 can modify user interface 106 by displaying a prompt to user 110 to suggest taking a break. For example, the prompt may be a prompt to user 110 such as “You've been working for a long period of time and you're typing quality has decreased. Taking a break can reduce stress and increase productivity.” However, examples of the disclosure are not limited to the above prompt.

Modification of user interface 106 can include modifying a type of web form from a first type to a second type. As used herein, the term “web form” refers to a form that allows a user to enter data that is sent to a server for processing. Web forms may include text inputs, dropdown selections, radio buttons, among other types of web forms.

The user profile associated with user 110 may include settings based on an erroneous typing profile. In other words, user 110 may not be a good typist (e.g., low words per minute, low spelling accuracy, long pauses between key strokes, etc.) Based on the user profile associated with user 110, computing device 102 can modify user interface 106 from a first type of web form, which may call for many text inputs, to a second type of web form, which may use less text inputs. For example, computing device 102 can modify user interface from a text input web form to a radio button web form so as to decrease the amount of usage of input device 104 for user 110.

Modification of user interface 106 can include adapting a gaming experience of a video game based on the inputs from a controller. For example, video game experiences such as a story progression, game difficulty, and/or game settings (e.g., brightness, contrast, color options, video resolution, etc.), among other experiences may be modified based on the inputs from the controller. For instance, analysis of typing pattern metrics input to the controller may indicate a particular typing pattern metric is below a threshold typing pattern metric. In some examples, the typing pattern metric being below the threshold typing pattern metric may indicate the user is tired (e.g., time between keystrokes/button presses is slow, button patterns are erroneous/slow, etc.) and, in response, computing device 102 can modify game settings (e.g., video output settings such as brightness, contrast, etc.) to ease an effect on the user's eyes. In another example, the typing pattern metric being below the threshold typing pattern metric may indicate and computing device 102 may modify the game difficulty based on the user being tired. However, examples of the disclosure are not limited to the above described modifications to user interface 106 to adapt a game experience.

Modification of user interface 106 can include determining an authenticity of the input 108 received from input device 104. As used herein, the term “authenticity of an input” refers to a genuineness of authorship of an input to computing device 102. For example, an authentic input 108 to computing device 102 can be an input by user 110 to computing device 102 under a user profile associated with user 110. Conversely, a counterfeit input 108 to computing device 102 can be an input by a different user to computing device 102 under a user profile associated with user 110.

For example, user 110 may be writing a computer program code with computing device 102. Computing device 102 can analyze the inputs 108 received from input device 104 by user 110 to determine that, based on the analyzed typing pattern from user 110, that the user profile is associated with user 110. However, a different (e.g., unauthorized) user may gain access to computing device 102 and computing device 102 can receive an input from the unauthorized user to modify the computer program code. Computing device 102 can analyze the inputs received from input device 104 by the unauthorized user to determine that, based on the analyzed typing pattern from the unauthorized user, that the input did not come from user 110.

In some examples, computing device 102 can determine the input from the unauthorized user is not authentic (e.g., counterfeit) and can prevent the input from being effectuated. As used herein, the term “effectuated” refers to put into operation. For example, computing device 102 can prevent the inputs from modifying the computer program code.

In some examples, computing device 102 can determine the input from the unauthorized user is not authentic (e.g., counterfeit) and can certify the inputs as being counterfeit. As used herein, the term “counterfeit” refers to fraudulent. For example, computing device 102 can indicate the inputs to the computer program code as being counterfeit. Accordingly, the authorized user, or another user who may have permissions to modify the computer program code, can remove the counterfeit computer program code.

While computing device 102 is described above as preventing inputs from modifying the computer program code and/or indicating the inputs as counterfeit, examples of the disclosure are not so limited. For example, computing device 102 can perform any other operation in response to the input from the unauthorized user as not authentic.

In some examples, multiple users may be writing the computer program code. Accordingly, there may be multiple inputs to the computer program code. Computing device 102 can analyze inputs received by the multiple users and, based on individual typing patterns of the multiple users, can authenticate the multiple inputs to the computer program code.

Although described above as authenticating inputs to a computer program code, examples of the disclosure are not so limited. For example, computing device 102 can authenticate input device 104 inputs to a text document, an image, and/or other inputs to computing device 102 based on the typing patterns. In some examples, an analyzed typing pattern can be attached as a meta field to a document to certify an authenticity of the inputs.

User interface modification according to the disclosure can allow for a user to be presented a uniquely tailored user experience. Utilizing an adaptive user profile can help a user accomplish various tasks in a simplified manner. User interface modification can provide the unique user experience which can leave a user feeling valued relative to a standardized user experience with standard settings and/or information, which may cause a user to want to return to using the computing device, increasing customer retention.

FIG. 2 is a diagram of an example computing device 202 for user interface modification consistent with the disclosure. As described herein, the computing device 202 may perform a number of functions related to typing patterns. Although not illustrated in FIG. 2, the computing device 202 may include a processor and a machine-readable storage medium. Although the following descriptions refer to a single processor and a single machine-readable storage medium, the descriptions may also apply to a system with multiple processors and multiple machine-readable storage mediums. In such examples, the computing device 202 may be distributed across multiple machine-readable storage mediums and the computing device 202 may be distributed across multiple processors. Put another way, the instructions executed by the computing device 202 may be stored across multiple machine-readable storage mediums and executed across multiple processors, such as in a distributed or virtual computing environment.

Processing resource 214 may be a central processing unit (CPU), a semiconductor based microprocessor, and/or other hardware devices suitable for retrieval and execution of machine-readable instructions 218, 220, 222 stored in a memory resource 216. Processing resource 214 may fetch, decode, and execute instructions 218, 220, 222. As an alternative or in addition to retrieving and executing instructions 218, 220, 222, processing resource 214 may include a plurality of electronic circuits that include electronic components for performing the functionality of instructions 218, 220, 222.

Memory resource 216 may be any electronic, magnetic, optical, or other physical storage device that stores executable instructions 218, 220, 222 and/or data. Thus, memory resource 216 may be, for example, Random Access Memory (RAM), an Electrically-Erasable Programmable Read-Only Memory (EEPROM), a storage drive, an optical disc, and the like. Memory resource 216 may be disposed within computing device 202, as shown in FIG. 2. Additionally and/or alternatively, memory resource 216 may be a portable, external or remote storage medium, for example, that computing device 202 to download the instructions 218, 220, 222 from the portable/external/remote storage medium.

The computing device 202 may include instructions 216 stored in the memory resource 216 and executable by the processing resource 214 to analyze an input received from a keyboard for a typing pattern. The typing pattern can include typing pattern metrics including a time between each keystroke in the typing pattern, a time each key is pressed during each keystroke in the typing pattern, spelling accuracy in the typing pattern, and/or words per minute in the typing pattern, among other typing pattern metrics.

The computing device 202 may include instructions 220 stored in the memory resource 216 and executable by the processing resource 214 to determine a user profile corresponding to the analyzed typing pattern from the keyboard. For example, computing device 202 can determine that based on a time between each keystroke in the typing pattern, a time each key is pressed during each keystroke in the typing pattern, spelling accuracy in the typing pattern, and/or words per minute in the typing pattern, a particular user corresponding to a user profile is utilizing computing device 202.

The computing device 202 may include instructions 222 stored in the memory resource 216 and executable by the processing resource 214 to modify a user interface of the computing device based on the determined user profile. For example, computing device 202 can modify various settings and/or information (e.g., display settings, application settings, network connections, and/or other settings/information) associated with the user profile of the particular user.

FIG. 3 is a diagram of an example system 324 for user interface modification consistent with the disclosure. In the example of FIG. 3, system 324 includes a processing resource 314 (e.g., processing resource 214, previously described in connection with FIG. 2) and a non-transitory machine readable storage medium 326. Although the following descriptions refer to an individual processing resource and an individual machine readable storage medium, the descriptions may also apply to a system with multiple processing resources and multiple machine readable storage mediums. In such examples, the instructions may be distributed across multiple non-transitory machine readable storage mediums and the instructions may be distributed across multiple processing resources. Put another way, the instructions may be stored across multiple non-transitory machine readable storage mediums and executed across multiple processing resources, such as in a distributed computing environment.

Processing resource 314 may be a central processing unit (CPU), microprocessor, and/or other hardware device suitable for retrieval and execution of instructions stored in non-transitory machine readable storage medium 326. In the particular example shown in FIG. 3, processing resource 314 may receive, determine, and send instructions 328, 330, and 332. As an alternative or in addition to retrieving and executing instructions, processing resource 314 may include an electronic circuit comprising an electronic component for performing the operations of the instructions in non-transitory machine readable storage medium 324. With respect to the executable instruction representations or boxes described and shown herein, it should be understood that part or all of the executable instructions and/or electronic circuits included within one box may be included in a different box shown in the figures or in a different box not shown.

The non-transitory machine readable storage medium 326 may be any electronic, magnetic, optical, or other physical storage device that stores executable instructions. Thus, non-transitory machine readable storage medium 326 may be, for example, Random Access Memory (RAM), an Electrically-Erasable Programmable Read-Only Memory (EEPROM), a storage drive, an optical disc, and the like. The executable instructions may be “installed” on the system 324 illustrated in FIG. 3. Non-transitory machine readable storage medium 326 may be a portable, external or remote storage medium, for example, that allows the system 324 to download the instructions from the portable/external/remote storage medium. In this situation, the executable instructions may be part of an “installation package”. As described herein, non-transitory machine readable storage medium 326 may be encoded with executable instructions related to typing patterns. That is, using processing resource 314, non-transitory machine readable storage medium 326 may modify a user interface based on a determined user profile, among other operations.

Instructions 328 to analyze an input received from a keyboard for a typing pattern, when executed by processing resource 314, may cause system 324 to analyze an input received from a keyboard for a typing pattern, where the typing pattern includes a typing pattern metric. Typing pattern metrics can include a time between each keystroke in the typing pattern, a time each key is pressed during each keystroke in the typing pattern, spelling accuracy in the typing pattern, words per minute in the typing pattern, pressure applied during each keystroke, and/or length of time between N number of consecutive key strokes, among other typing pattern metrics.

Instructions 330 to determine a user profile corresponding to the analyzed typing pattern from the keyboard, when executed by processing resource 314, may cause system 324 to determine a user profile corresponding to the analyzed typing pattern from the keyboard. For example, based on a time between each keystroke in the typing pattern, a time each key is pressed during each keystroke in the typing pattern, spelling accuracy in the typing pattern, and/or words per minute in the typing pattern, a particular user corresponding to a user profile is utilizing computing device.

Instructions 332 to modify a user interface based on the determined user profile, when executed by processing resource 314, may cause system 324 to modify a user interface based on the determined user profile. For example, various settings and/or information (e.g., display settings, application settings, network connections, and/or other settings/information) can be modified so that the settings match settings associated with the determined user profile of the particular user.

FIG. 4 is an example of a method 434 consistent with the disclosure. Method 434 may be performed, for example, by a computing device (e.g., computing device 102, 202, previously described in connection with FIGS. 1 and 2, respectively).

At 436, the method 434 may include analyzing, by a computing device, an input received from a keyboard for a typing pattern. The typing can include a typing pattern metric. Typing pattern metrics can include, for example, a time between each keystroke in the typing pattern, a time each key is pressed during each keystroke in the typing pattern, spelling accuracy in the typing pattern, and/or words per minute in the typing pattern, among other typing pattern metrics.

At 438, the method 434 may include determining, by the computing device, a user profile corresponding to the analyzed typing pattern from the keyboard. For example, the computing device can determine that based on various typing pattern metrics such as a time between each keystroke in the typing pattern, a time each key is pressed during each keystroke in the typing pattern, spelling accuracy in the typing pattern, and/or words per minute in the typing pattern, a particular user corresponding to a particular user profile is utilizing the computing device.

At 440, the method 434 may include modifying, by the computing device, a user interface of the computing device based on the determined user profile. For example, various settings and/or information (e.g., display settings, application settings, network connections, and/or other settings/information) associated with the user profile of the particular user can be modified. In some examples, the user interface of the computing device can be modified in response to the typing pattern metric being below a threshold typing pattern metric.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure, and should not be taken in a limiting sense. As used herein, “a plurality of” an element and/or feature can refer to more than one of such elements and/or features.

What is claimed:

1. A computing device, comprising:
a processing resource; and
a memory resource storing non-transitory machine-readable instructions to cause the processing resource to:
analyze an input received from an input device for a typing pattern;
determine a user profile corresponding to the analyzed typing pattern from the input device; and
modify a user interface of the computing device based on the determined user profile.

2. The computing device of claim 1, the memory resource storing instructions to determine an authenticity of the input received from the input device.

3. The computing device of claim 2, the memory resource storing instructions to, in response to the analyzed typing pattern not matching that of the user profile, at least one of:
prevent the input received by the input device from being effectuated; and
certify the input received by the input device as being counterfeit.

4. The computing device of claim 1, wherein the analyzed typing pattern includes a typing pattern metric that is below a threshold typing pattern metric.

5. The computing device of claim 4, wherein the instructions to modify the user interface include instructions to enable text prediction based on the typing pattern metric being below the threshold typing pattern metric.

6. The computing device of claim 1, wherein the analyzed typing pattern includes a typing pattern metric that is below a threshold typing pattern metric.

7. The computing device of claim 5, wherein the instructions to modify the user interface include instructions to generate and display a suggestive prompt based on the typing pattern metric being below the threshold typing pattern metric.

8. A non-transitory machine-readable storage medium having stored thereon machine-readable instructions to cause a processing resource to:
analyze an input received from a keyboard for a typing pattern, wherein the typing pattern includes a typing pattern metric;
determine a user profile corresponding to the analyzed typing pattern from the keyboard; and
modify a user interface based on the determined user profile, wherein modifying the user interface includes modifying settings to match settings associated with the determined user profile.

9. The medium of claim 8, wherein the instructions to modify the user interface include instructions to adapt a gaming experience of a video game.

10. The medium of claim 9, wherein the instructions to adapt the gaming experience of the video game include instructions to modify video output settings in response to the typing pattern metric being below a threshold typing pattern metric.

11. The medium of claim 8, wherein the instructions to modify the user interface include instructions to modify a type of web form from a first type to a second type.

12. The medium of claim 8, wherein the typing pattern metric includes at least one of:
a time between each keystroke in the typing pattern;
a time each key is pressed during each keystroke in the typing pattern;
spelling accuracy in the typing pattern; and
words per minute in the typing pattern.

13. A method, comprising:
analyzing, by a computing device, an input received from a keyboard for a typing pattern, wherein the typing pattern includes a typing pattern metric;
determining, by the computing device, a user profile corresponding to the analyzed typing pattern from the keyboard; and
modifying, by the computing device, a user interface of the computing device based on the determined user profile, wherein the user interface of the computing device is modified in response to the typing pattern metric being below a threshold typing pattern metric.

14. The method of claim 13, wherein the method includes analyzing the typing pattern metric via machine learning.

15. The method of claim 14, wherein the method further includes generating the user profile that corresponds with a particular user based on the analyzed typing pattern metric via the machine learning.
